(19) United States
(12) Patent Application Publication
(10) Pub. No.: US 2019/0171981 A1
(43) Pub. Date: Jun. 6, 2019

(54) METHOD AND SYSTEM OF ORGANIZING AND OPERATING A PROFESSIONAL TEAM GOLF LEAGUE

(71) Applicant: Juan Antonio Rodriguez, Hartville, OH (US)

(72) Inventor: Juan Antonio Rodriguez, Hartville, OH (US)

(21) Appl. No.: 16/205,709

(22) Filed: Nov. 30, 2018

Related U.S. Application Data
(60) Provisional application No. 62/592,734, filed on Nov. 30, 2017.

(51) Int. Cl. G06Q 10/06; A63F 9/02

(52) U.S. Cl. CPC G06Q 10/063; A63F 9/02

(57) ABSTRACT

The present invention relates to a method of operating a professional golf league. The system involves drafting players onto teams for which they will compete. Teams can consist of many players, and can include both men and women. Teams then compete against each other in multi-stage competition involving different scoring methods for each stage. In the first stage, the teams play “best-ball”; in the second stage, a team's score is calculated using the lowest aggregate of the players on the hole; and in the third stage, a team plays “worst-ball”. Such a format places a greater emphasis on team play rather than on any one individual on the team, and further allows players to enter into a professional golf career while still developing their overall game.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 62/592,734, entitled “METHOD AND SYSTEM OF ORGANIZING AND OPERATING A PROFESSIONAL TEAM GOLF LEAGUE”, filed Nov. 30, 2017. The contents of the above referenced application is incorporated herein by reference in its entirety.

### FIELD OF THE INVENTION

This invention relates generally to the field of sports, and more specifically, to organizing and operating a professional team golf league, and, in particular, to a team-based, multi-stage competition format.

### BACKGROUND OF THE INVENTION

Modern golf originated in the 15th-century in Scotland, though the game's ancient origins are unclear and uncertain. Golf is a traditional club and ball sport in which players use various clubs to hit balls into a series of holes on a given course in as few strokes as possible. Unlike most ball games, however, Golf does not require a standardized playing area. It is played on a course with an arranged progression of either nine (9) or eighteen (18) holes. Though each hole will generally contain standardize features, such as the tee, fairway, rough (long grass), hazards (sand traps, water, rocks, fescue, etc.), and putting green, each hole on a course is unique in its specific layout and arrangement.

Traditionally, every round of golf is based on playing a number of holes in a given order. A “round” of golf typically consists of 18 holes that are played in the order determined by the course layout. Each hole is played once in the round on a standard course of 18 holes. Any number of players can participate in a round of golf, though typically, groups having between 1 and 4 players will play each hole at a time.

Though only one ball is typically needed per player, each player will generally require various clubs in order to play a round of golf. Each club is composed of a shaft with a lance (or grip) on the top end and a club head on the bottom end. The club head will vary between different types of clubs based on the intended use of each club. Woods are large-headed, long-shafted clubs that are meant to propel the ball a long distance from relatively “open” lies, such as the box or fairway. Irons are shorter-shafted clubs with a metal head primarily consisting of a flat, angled striking face. Irons vary by the angle of the striking face to change the loft produced by each iron, and are chosen based on the distance a player intends to hit the ball, what obstacles might lie between the ball and the hole, etc. Putters are balanced clubs designed to roll the ball along the green and into the hole. Putters are virtually always used on the green or in the surrounding rough/fringe. In traditional rules, a maximum of 14 clubs are allowed in a player's bag at any one time during a stipulated round.

There are two basic forms of golf play, though additional variations have developed. In “match play”, two players (or two teams) play each hole as a separate contest against each other. The party (or team) with the lower score wins that hole, or if the scores of both players (or teams) are equal, the hole is “halved” (or tied). The game is won the by the party (or team) that wins more holes than the other. In the case that one player or team has taken a lead that cannot be overcome in the number of holes remaining to be played, the match is deemed to be won by the party in the lead, and the remainder of the holes need not be played.

Alternatively, in “stroke play”, the score achieved for each and every hole of the round or tournament is added to produce a total score and the player with the lowest score wins. Stroke play is the version of golf most commonly played by professional golfers. If there is a tie after the regulation number of holes in a professional tournament, a playoff takes place between all tied players. Playoffs either are sudden death or employ a pre-determined number of holes, anywhere from three to a full eighteen. In sudden death, a player who scores lower on a hole than all of his or her opponents wins the match. If at least two players remain tied after such a playoff using a pre-determined number of holes, then play continues in sudden death format, where the first player to win a hole wins the tournament.

Other common forms of competition include bogey competition, skins, 9-points, stableford, team play including foursome and fourball, and other unofficial team variations such as scramble, champagne scramble, better ball or best-ball, greensome, and wolf.

A “bogey competition” is a scoring format seen at informal tournaments. Its scoring is similar to match play, except each player compares their hole score to the hole's par rating instead of the score of another player. The player “wins” the hole if they score a birdie or better, they “lost” the hole if they score a bogey or worse, and they “halve” the hold by scoring par. By recording only this simple win-loss-halve score on the sheet, a player can shrug off a very poorly played hole with a simple “-” mark and move on. As used in competitions, the player or pair with the best win/loss differential will win the competition.

A “skins” game is a variation on match play where each hole has an amount of money (the “skin”) attached. This may be prize money at the professional level, or an amount wagered for each hole among amateur players. The player with the lowest score on the hole wins the skin for that hole; if two or more players tie for the lowest score, the skin carries over to the next hole. This continues until a player wins a hole outright, which may (and often does) result in a player receiving money for a previous hole that they had tied for. If players tie the 18th hole, either all players or only the tying players repeat the 18th hole until an outright winner is decided for that hole (and all undecided skins).

A “9-points” game is another variant of match play typically played among threesomes, where each hole is worth a total of nine points. The player with the lowest score on a hole receives five points, the next lowest score 3 points, and the next lowest score 1 point. Ties are generally resolved by summing the points contested and dividing them among the tying players; a two-way tie for first is worth four points to both players; a two-way tie for second is worth two points to both players; a three-way tie is worth three points to all players. The player with the highest score after 18 holes wins the game.

The “stableford” system is a simplification of stroke play that awards players points based on their score relative to the hole's par; the score for a hole is calculated by taking the par score, adding 2, then subtracting the player's hole score, making the result zero if negative. Alternately stated, a double bogey or worse is zero points, a bogey is worth one point, par is two, birdie is three, an eagle is four, and so on.

“Foursome” play is played between two teams of two players each, in which each team has only one ball and players alternate playing it.

“Fourball” is also played between two teams of two players each, but every player plays their own ball and for each team, the lower score on each hole counts. Fourballs can be played as math play or stroke play.

A “scramble”, alternatively known as ambrose or best-shot, is another team variation where each player in a team tees off on each hole, and then the best shot for the team is determined. Every player then plays their second shot from within a club-length of where the best shot has come to rest (and no closer to the hole). This procedure is repeated until the hole is finished.

“Champagne scramble” is a combination of scramble and best-ball, where only the first shot of each hole is a scramble. All players tee off and then decide which shot was the best. Each player then finishes the hole from that position. The best score amongst the team's players is counted as the team's score.

“Better ball” or “best-ball” is a variation where each player on the team plays their ball, but only the best ball from the team is counted as the team's score.

“Greensome”, also known as Scotch Foursomes or modified alternate shot, is played in pairs. Both players tee off, and then pick the best shot as in scramble. The player who did not shoot the best first shot plays the second shot. The play then alternates as in a foursome. A variant of greensome is sometimes played where the opposing team chooses which of their opponent's tee shots the opponents should use.

While the foregoing methods of playing golf have met with varying degrees of success there remains a need in the art for a competition scoring system where teams compete against each other by using a multi-stage scoring system, and an organization developed around such a scoring system which allows players to develop different aspects of their golf game while competing professionally.

### SUMMARY OF THE INVENTION

The present invention relates to a method of operating a professional golf league. The system involves drafting players onto teams for which they will compete. Teams can consist of many players, and can include both men and women. Teams then compete against each other in multi-stage competition involving different scoring methods for each stage. In the first stage, the teams play “best-ball”; in the second stage, a team's score is calculated using the lowest score and highest score aggregate of the players on the hole; and in the third stage, a team plays “worst-ball”. Such a format places greater emphasis on team play rather than on any one individual on the team, and further allows players to enter into a professional golf career while still developing their overall game.

Accordingly, it is a primary objective of the present invention to provide a professional team golf league where teams play a multi-stage format.

It is a further objective of the present invention to provide a professional team golf league where players are drafted on the teams by coaches and/or team owners.

It is yet another objective of the present invention to provide a multi-stage team golf competition format to emphasize play between teams rather than between individuals.

It is further an objective of the present invention to provide a three-stage team golf competition where in the first stage teams play “best-ball”, in the second stage teams aggregate their scores, and the in the third stage teams play “worst-ball”.

It is a still further objective of the present invention to provide a professional team golf league which helps younger golfers play golf professionally even when certain aspects of their game need development.

It is an additional objective of the present invention to provide a professional team golf league where coaches can select different players for different holes based on the unique aspects of the hole and the individual strengths of each player.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### DETAILED DESCRIPTION OF THE INVENTION

The method of organizing and operating a professional team golf league includes creating teams ranging between four and twenty-five players. Teams can be all men, all women, or can be mixed gender.

Teams can be selected including an equal number of male and female players, leading to teams of eleven men and eleven women. Owners operating in connection with team coaches can select team members from a draft, or through trades, similar to other professional sports, where collegiate players can enter the draft as well as non-collegiate players who desire to play in the professional league. The player's abilities are assessed and then coaches/owners can draft players to their teams based on the skills and potentials of the different athletes.

Teams can then compete against each other throughout a season of play. Two teams can compete against each other over the course of a single weekend. In another embodiment, more than two teams compete against each other in a single weekend competition.

In a first embodiment teams compete head to head at a golf course in a three-stage format. The teams can compete on a traditional golf course, or alternatively, specially designed courses can be employed so long as they maintain the format of a golf course in that there are a plurality (typically 18) of “holes”—or, mini courses each having a tee box to start, a fairway between the rough, all leading to a green with a hole. Hazards can be employed along the course as is typical with a traditional golf game to make the course more challenging.

In the first embodiment two teams compete head-to-head. Each time has between 4 and 25 players, and a coach. A format, or method of playing golf, is selected for playing each of three rounds of golf. The formats can be pre-selected before the event, or selected at the time of play. Formats can include such common formats as: traditional rules, match play, stroke play, bogey competition, skins, 9-points, stableford, foursome, fourball, scrable, champagne scramble, better ball or best-ball, greensome, or wolf.

The teams then complete a first round of golf under the rules of the format selected for the first round. The coach then selects individuals to participate during each hole of the round, either selecting the player for each shot, or the players competing in each hole of the round, depending on the format of play. The teams continue until they have played all three rounds of golf

In this embodiment, each of the three rounds is played under a different rules format, however, in an alternate embodiment, each round can be selected at random from a list of possible formats, which allows for the possibility that the same format can be selected for multiple rounds.

As the two teams complete each round, score is kept based on the rules of the format, and a running total is used by the coaches to determine how to approach each hole within the round. At the end of the three rounds, the team with the lowest score (i.e., the team that had the fewest number of strokes to complete each round) wins the competition.

In another embodiment, teams are comprised of ten men and ten women. A coach then selects four men and four women from the team to compete on a given hole. The coach selects the players for the hole based on the unique aspects of the hole, deciding which players' skill sets are best suited to help the team on each hole. The teams compete on each hole of the course in this manner, selecting different players based on each unique hole.

In another embodiment, teams compete in a multi-stage format, competing where different scoring rules are used with each stage so that the team score is based more on the team as a whole rather than on any one star individual.

One way of competing in the multi-stage format is playing a three-stage format. In the first stage, the teams play the course using the “best-ball” rules, where the best ball from the team counts as the score. In the second stage play the course again, but this time the teams play the aggregate score of their players on a given hole. In the third stage the teams play the course using a “worst-ball” scoring system, where the worst score from the team counts as the team's score for a given hole.

In another embodiment, teams can compete using a multi-stage format where scoring changes between formats using different scoring methods. An alternate embodiment can include playing a scramble as the first stage, aggregate the scores in the second stage, and play an alternate scramble as the third stage where teams play off the worst shot rather than the best shot.

In an alternative embodiment, players are instructed of the scoring method the night before or the day of play. In the event of rain each team shall receive an equal number of points for that days play for play to resume the following day.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. The method of operating a professional golf league comprising the steps of:
providing a plurality of courses, each of said plurality of courses comprising a starting area, a fairway, and a green, each said green including hole for receiving a golf ball;
providing a first team of players, said first team of players having at least one golf ball, said first team of players having an objective to move said at least one golf ball from said starting area to said hole on each of said plurality of courses, wherein said movement of said at least one golf ball is accomplished by striking said at least one golf ball with at least one club;
providing a second team of players, said second team of players having at least one golf ball, said second team of players having an objective to move said at least one golf ball from said starting area to said hole on each of said plurality of courses, wherein said movement of said at least one golf ball is accomplished by striking said at least one golf ball with at least one club;
selecting a first method of completing said objective to move said at least one golf ball from said starting area to said hole on each of said plurality of courses;
selecting a second method of completing said objective to move said at least one golf ball from said starting area to said hole on each of said plurality of courses;
selecting a third method of completing said objective to move said at least one golf ball from said starting area to said hole on each of said plurality of courses; said first team of players and said second team of players playing said first method of completing said objective to move said at least one golf ball from said starting area to said hole on each of said plurality of courses;
recording the number of times said first team of players struck said at least one golf ball during said first method of completing said objective to move said at least one golf ball from said starting area to said hole on each of said plurality of courses;
said first team of players and said second team of players playing said second method of completing said objective to move said at least one golf ball from said starting area to said hole on each of said plurality of courses;
recording the number of times said second team of players struck said at least one golf ball during said second method of completing said objective to move said at least one golf ball from said starting area to said hole on each of said plurality of courses;
said first team of players and said second team of players playing said third method of completing said objective to move said at least one golf ball from said starting area to said hole on each of said plurality of courses;
recording the number of times said first team of players struck said at least one golf ball during said third method of completing said objective to move said at least one golf ball from said starting area to said hole on each of said plurality of courses; and
determining a winning team.

2. The method of operating a professional golf league as set forth in claim 1, including the steps of adding the number of times said first team of players struck said at least one golf ball during said first, second, and third methods of completing said objective to move said at least one golf ball from said starting area to said hole on each of said plurality of courses to arrive at a first score, and adding the number of times said second team of players struck said at least one golf ball during said first, second, and third methods of completing said objective to move said at least one golf ball from said starting area to said hole on each of said plurality of courses to arrive at a second score.

3. The method of operating a professional golf league as set forth in claim 2, including the steps of comparing said first score to said second score to determine said winning team.

4. The method of operating a professional golf league as set forth in claim 3, wherein said winning team is the team of players with the lowest score.

5. The method of operating a professional golf league as set forth in claim 1, wherein each of said first and second team of players comprises of plurality of players and a coach.

6. The method of operating a professional golf league as set forth in claim 5, wherein said plurality of players on each of said first and second team of players includes male players and females.

7. The method of operating a professional golf league as set forth in claim 6, wherein said plurality of players on said first team of players is selected by said coach for said first team of players.

8. The method of operating a professional golf league as set forth in claim 7, including the step of drafting a plurality of player for said first team of players during an annual draft.

9. The method of operating a professional golf league as set forth in claim 5, wherein for each strike of said at least one golf ball to move said at least one golf ball from said starting area to said hole on each of said plurality of courses said coach selects one player from said plurality of players.

10. The method of operating a professional golf league as set forth in claim 1, wherein said first method of completing said objective to move said at least one golf ball from said starting area to said hole on each of said plurality of courses is different from said second method of completing said objective to move said at least one golf ball from said starting area to said hole on each of said plurality of courses, and said first and second methods of completing said objective to move said at least one golf ball from said starting area to said hole on each of said plurality of courses are different from said third method of completing said objective to move said at least one golf ball from said starting area to said hole on each of said plurality of courses.
